(19) United States
(12) Patent Application Publication
(10) Pub. No.: US 2009/0298489 A1
(43) Pub. Date: Dec. 3, 2009

(54) SYSTEM AND METHOD FOR A CONVERGED NETWORK-BASED ADDRESS BOOK

(75) Inventors: Suresh Chitturi, Irving, TX (US); Brian Edward Anthony McColgan, Mississauga (CA); Gaelle Christine Martin-Cocher, Mississauga (CA)

Correspondence Address: RESEARCH IN MOTION;ATTN: GLENDA WOLFE, BUILDING 6, BRAZOS EAST, SUITE 100, 5000 RIVERSIDE DRIVE, IRVING, TX, 75039, US

(73) Assignee: RESEARCH IN MOTION LIMITED, Waterloo (CA)

(21) Appl. No.: 12/472,706

(22) Filed: May 27, 2009

Related U.S. Application Data
(60) Provisional application No. 61/056,418, filed on May 27, 2008.

(51) Int. Cl. H04M 3/00

(52) U.S. Cl. 455/418

(57) ABSTRACT

A converged address book system having a converged address book (CAB) client for managing contact information, the CAB client including: an interface for interacting with a CAB server; and a synchronization interface for communicating with a synchronization module for interacting with a data synchronization enabler for synchronization between the CAB client and CAB server; the interface allowing the CAB client to manage contact information by making requests to and receiving responses from the CAB server. The CAB server including an interface for interacting with a CAB client; a data synchronization manager for synchronizing information between at least one CAB user device and the CAB server; a data synchronization interface for synchronizing data with the CAB client; a subscription manager for managing CAB subscription and authorization information; a document management interface for communicating with a CAB XMDS; and an XDMC for accessing and manipulate CAB data stored in the XDMS.

### CROSS-REFERENCE TO RELATED APPLICATIONS

The present application claims the benefit of U.S. Provisional Patent Application 61/056,418, filed May 27, 2008, the entire disclosure of which is incorporated by reference herein in its entirety.

### FIELD OF THE DISCLOSURE

The present disclosure relates to a converged address book system.

### BACKGROUND

In a social context or setting, an address book is a key enabler for establishing social relationships between people. A typical address book contains a list of contact entries, with each contact entry comprising a list of contact information. Such information could include, but is not limited to, a name, physical address, email address, telephone number, personal identification number, instant messaging identifier, among others, which enables one user to contact another user. In addition to the contact entries, the address book system may also include a user's own personal contact information.

Growing innovation across service domains and mobile devices creates a number of ways to organize and manage contact information. With rapid growth in the usage of address books on end-user devices, the mobile industry has produced many different types of address book systems, associated data formats and protocols to manage the same. While this offers more choice to end users, it poses a very bad user experience and causes interoperability issues across differing address book applications. In other words, there is a lack of unified user experience and inconsistent user experience across devices with regard to address book applications.

Several activities are under way within various standards organizations such as the Open Mobile Alliance (OMA) Converged Address Book (CAB), Open Mobile Terminal Platform (OMTP) and Internet Engineering Task Force (IETF), to provide a converged address book system. However, a gap currently exists in terms of defining an underlying system architecture that would permit users to manage (e.g. add, modify, delete), publish, subscribe, search, and share information as part of a converged address book across various devices over a network. Interaction with legacy or external address book systems (e.g. import) may also be desirable for a standard converged address book system.

### BRIEF DESCRIPTION OF THE DRAWINGS

The present disclosure will be better understood with reference to drawings in which:

FIG. 1 is a block diagram illustrating an exemplary system architecture for a network-based converged address book system;

FIG. 2 is a flow diagram illustrating a contact publish data flow;

FIG. 3 is a flow diagram illustrating a contact subscribe/notify data flow;

FIG. 4 is a flow diagram illustrating a contact subscribe/notify data flow utilizing a proxy for communications;

FIG. 5 is a flow diagram illustrating a contact share data flow;

FIG. 6 is a flow diagram illustrating a contact share data flow utilizing a proxy for communications;

FIG. 7 is a flow diagram illustrating a contact send data flow;

FIG. 8 is a flow diagram illustrating a contact search data flow;

FIG. 9 is a flow diagram illustrating an interaction with legacy address book systems;

FIG. 10 is a flow diagram illustrating an interaction with legacy address book systems utilizing a proxy for communications;

FIG. 11 is a flow diagram showing data synchronization between a device and network side; and

FIG. 12 is a block diagram of an exemplary mobile device apt to be used with the present disclosure.

### DETAILED DESCRIPTION

The present disclosure provides a converged address book client on a device configured to manage contact information through a converged address book system, the converged address book client comprising: an interface for interacting with a converged address book server; and a synchronization interface configured to communicate with a synchronization module for interacting with a data synchronization enabler for synchronization between the converged address book client and converged address book server; wherein the interface allows the converged address book client to manage contact information by making requests to and receiving responses from the converged address book server.

The present disclosure further provides a converged address book server within a converged address book system, the converged address book server comprising: an interface for interacting with a converged address book client; a data synchronization manager configured to synchronize information between at least one converged address book user device and the converged address book server; a data synchronization interface, said data synchronization interface configured to communicate between the data synchronization manager and a data synchronization enabler for synchronizing data with the converged address book client; a subscription manager configured to manage converged address book subscription and authorization information; a document management interface for communicating with a converged address book extensible markup language document management system; and an extensible markup language document management client configured to access and manipulate converged address book data stored in the extensible markup language document management system.

The present disclosure further provides a network repository for use in a converged address book system comprising: memory for storing converged address book system related information; an interface allowing access to the converged address book system related information by a converged address book client or converged address book server, wherein said network repository further specifies data semantics associated with said converged address book system related information.

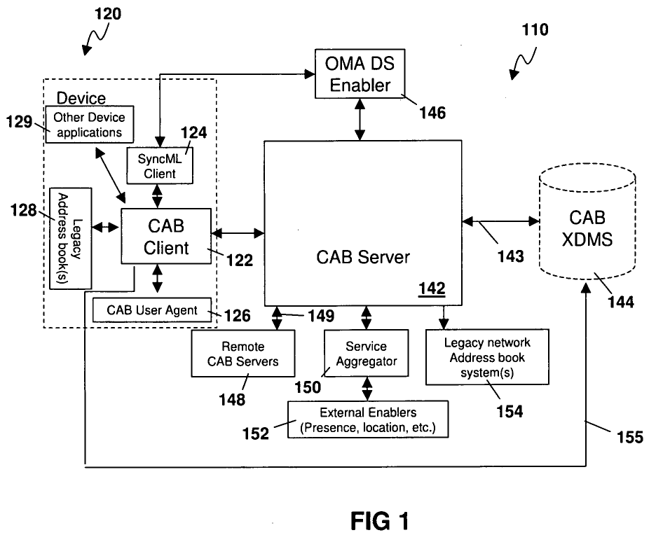

Reference is now made to FIG. 1. FIG. 1 shows an exemplary system architecture for a network-based converged address book system as is seen in FIG. 1, the system is divided into a network side 110 and a device side 120.

Device side 120 could be part of any device on which a converged address book might be used. Examples include wireless devices such as cell phones, personal digital assistants, two-way pagers or other such devices. Device side 120 could further include wired devices such as personal computers, laptop computers, set-top boxes, or an arbitrary network entity acting on behalf of a device such as in proxy-based infrastructure systems, among others.

Device side 120 includes a Converged Address Book (CAB) client 122. CAB client 122 is a principal functional entity on the device side 120. CAB client 120 communicates with the CAB server 142, as described below. The interface between the CAB client 122 and CAB server 142 carries requests such as publish, subscribe, share, search, authentication, import, user preferences, among others from a user of the converged address book to the network side 110.

In one embodiment, the underlying protocol for the interface between CAB client 122 and CAB server 142 is implemented using Internet Protocol (IP) protocols such as HyperText Transfer Protocol (HTTP) or Session Initiation Protocol (SIP). Those skilled in the art may understand that other HTTP-based protocols such as XCAP, SOAP, XML-RPC, or REST may be used as an alternative to or in combination with standard HTTP protocol. Further, in one embodiment the body or the payload of the protocol may contain syntax or protocol to convey the requests.

For example, below is a HTTP example with a body in Extensible Markup Language (XML) that contains a search request sent from CAB client 122 to CAB server 142.

POST /org.openmobilealliance.cab
HTTP/1.1
Host: CAB.example.com
User-Agent: CAB-client
Date: Wed, 10 Oct 2007 12:07:22 GMT-05
...
Content-Type: application/CAB+xml
...
<?xml version=“1.0” encoding=“UTF-8”?>
<search id=”aa1234”>
<--------------------------request data for ‘search’ goes here.
</ search >

Similarly, requests may be sent to publish, subscribe, share, authenticate, import, or provide user preferences, among others. A similar message body can be used for SIP in an alternative embodiment.

In the XML above the search XML element includes an XML attribute identifier “id”. This identity mechanism allows CAB client 122 to correlate a given search request with a given search response.

A further functional block on device side 120 includes the SyncML Client 124. The primary responsibility of the SyncML Client 124 is to assist CAB client 122 to synchronize a user's personal contact information and address book data between the device side 120 and the network side 110. In one embodiment this is accomplished using an OMA Data Synchronization (DS) server such as OMA DS enabler 146, for example, through a SyncServerAgent.

The interface between CAB client 122 and SyncML Client 124 is responsible for communication between the CAB client and SyncML client to synchronize the user's personal contact information and address book data between the device and network.

A further logical block on device 120 includes the converged address book user agent 126. As will be appreciated by those skilled in the art, the CAB user agent 126 provides a visual user interface for end-users to connect to CAB client 122. In other words, CAB user agent 126 is a type of controller, and is responsible for all the user interface aspects of the CAB application including capturing the user input or actions and presenting the CAB related information to the end-user.

Thus CAB client 122 may also provide an external interface such that CAB user agent 126 or other clients on device side 120 can access or query CAB-related information and integrate it into their own application. For example, a presence application on the device may integrate CAB data to show both CAB and presence data to its user for the list of contacts for the user. This interface may be provided in the form of an application programming interface or API.

A further logical element on device 120 could, in some embodiments include a legacy address book(s) 128. Such address books include, existing email, instant messaging or other native device-based address books.

The interface between legacy address book 128 and CAB client 122 allows a CAB User to import a user's contact information to CAB client 122 from a native address book on the device such as the local device address book or Subscriber Identify Module (SIM) card based address book that can eventually be stored or synchronized with the network-based converged address book.

The interface between legacy address book 128 and CAB client 122 may also allow retrieval of contact entries from other device applications 129, such as, for example, an Instant Messaging (IM) client.

On network side 110, CAB server 142 is the main component of the CAB system. A CAB server 142 may include one or more of the following intrinsic functions. In one embodiment, a CAB server 142 may be configured to retrieve the CAB Client 122 request from a CAB XDMS wherein the XDMS functions as a proxy to the CAB Server 142 for interactions between the CAB client 122 and CAB server 142. This interaction is shown by indirect interface 155 in FIG. 1. CAB XDMS is described below.

CAB Server 142, User account manager: this function is responsible for managing authorized principal and user authentication and account information including user preferences and customization aspects. For example, the CAB User may wish to receive only a subset of information from the network or does not wish to receive notifications for every update that occurs in the network, among others.

CAB Server 142, Data synchronization (DS) manager: this function is responsible for configuration setup for synchronization of CAB-related data such as the address book and other CAB data between the device (or multiple CAB user devices) and the CAB server 142. It may also include a content transformation module that assists in transforming the data format stored in a CAB database to the transfer format used in SyncML that is delivered to CAB client 122, and vice versa. The DS manager is based on OMA DS which implies that it is responsible for data synchronization aspects such as conflict resolution, and maintaining a mapping table for data stored in the CAB XDMS on behalf of CAB client(s).

CAB Server 142, Subscription manager: this function is responsible for managing CAB User's subscription list and authorization information to keep subscribed users' contact information (i.e. contact information of the other users in the CAB user's address book) up to date on corresponding CAB devices. This is done by subscribing to other user's Personal Contact Card (PCC) data in the CAB XDMS, and storing the resulting updates in the user's address book. Subsequently the updates to the address book may be notified to the CAB user using, for example, an OMA DS notification from the CAB Server.

CAB Server 142, CAB XML Document Management Client (XDMC): this function is responsible for the access and manipulation of CAB data such as a PCC and address book information stored in a CAB database (which is also referred to as XDMS herein) and as well as other documents (e.g. User Preferences, User policies) that may be stored in the CAB XDMS. It is expected that this function may be used by other functions in the CAB Server 142 to access and manipulate data in CAB XDMS. The standard interfaces (represented by reference numeral 143 in FIG. 1) provided by the XDM Enabler may be used by the CAB XDMC. In one embodiment, a CAB XDMC located in the CAB Server 142 may also interact with other XDMSs, representing legacy address books or personal contact cards stored using XML Document Management but not part of the CAB XDMS.

CAB Server 142, Messaging unit: this function is responsible for messaging actions to satisfy contact send and contact share operations between CAB and non-CAB users. This function may also be viewed as a contact share function.

A further element on the network side 110 is the CAB XML Document Management Server (XDMS) 144. The CAB XDMS is the CAB database or a network repository and may contain one or more XDM application usages if needed to support a CAB system. The main responsibility of the CAB XDMS 144 is to store CAB-related information and to specify data semantics associated with that information. For example, storage could include a CAB User's personal contact card, CAB User's address book metadata, and CAB User policy or CAB User preferences based on a corresponding set of XML schemas and/or document type definitions.

The CAB XDMS 144 is further adapted to handle policy management functionality, such as that based on IETF common policy Request for Comments (RFC) 4745. This policy management function can be extended if needed for use by a converged address book system. CAB policy may be used to establish and apply authorization rules. It may also be used to apply various transforms to assist in the creation of contact views, for example, mapping personal contact card information and contact views, as defined by a given converged address book user.

A further element on network side 110 is the OMA DS enabler 146. The OMA DS enabler 146 on the network is responsible for synchronizing CAB related data that is stored on the network (for example in the CAB XDMS 144) to a device side CAB client 122. OMA DS Enabler uses SyncML as the synchronization protocol between two synchronization end points, which in this disclosure would be the CAB client 122 and CAB server 142.

In one embodiment the underlying transport protocol used for synchronization can be HTTP or Wireless Application Protocol (WAP) PUSH. The notification message framework defined by OMA DS may be used as a mechanism for indicating updates to CAB contact information in the network (e.g. address book data, personal contact card data) to the CAB user. For example, updates to contact information resulting from contact subscriptions, contact share, changes in a user's personal contact card information, CAB status, and import of non-CAB data to CAB, among others, may be indicated or used within the notification. In an alternate embodiment, the user may be prompted for approval prior to inserting the data into the network address book, which may also be among one of the notification types.

Notifications to the CAB User for the situations described above may also be delivered outside OMA DS framework through other mechanisms such as Short Message Service (SMS), Multimedia Message Service (MMS), email, instant messaging, SIP notify, SIP PUSH, WAP PUSH, among others. Such notifications may be managed and represented using a logical function “Notification” within the CAB Server 142.

A further component on the network side 110 may be remote CAB servers 148. It is possible that CAB servers may be hosted in other network domains. The remote CAB server interface 149 is an interface that permits interworking between trusted CAB systems in one or more network domains for features such as contact share, search, subscription, user preference and user data access, among others, supported by the CAB system as described in this disclosure. The interworking may occur via some type of NNI (Network-to-Network Interface).

A further element on network side 110 includes service aggregator 150. The main function of server aggregator 150 is to aggregate information from other external enablers 152, such as but not limited to presence, location, messaging, etc. In one embodiment, service aggregator 150 could be integrated with one or more of a Presence Aware Layer (PAL), a Condition Based Uniform Resource Identifier Selection (CBUS) enabler, and a Server User Profile Management (ServUserProf) enabler.

The use of service aggregator 150 enriches the CAB service with dynamic information. For example, it is possible for a CAB system to interwork with a presence platform (e.g. OMA Presence-PRS) through the service aggregator 150. This would allow a CAB system to display not only a user's contact information, but also the user's availability and/or reachability. It may also display only those contact means that a given contact wishes to be contacted on a given point in time. The service aggregator permits the CAB system to incorporate and interwork with other services to achieve new function points. For instance, the service aggregator can allow a given service (such as a user profile service, messaging service, presence service, among others) to retrieve from the CAB system, a user's CAB-related information, such as an address book, personal contact card, and user preference information.

A further entity on network side 110 includes network based legacy address book systems 154. Legacy address book systems are address book systems that may already exist. For example, Facebook™, Outlook™, Yahoo!™ contacts, among others, may already exist on the network side. These legacy systems are used to manage personal contact and address book information and are network based as well. The interactions with the legacy address books may occur through an interworking module within the CAB server 142 based on the request from the CAB User (e.g. an import request)

The above architecture could be utilized to provide converged address book functionality to various device clients within a network. Functionality for such a converged address book would include subscribing to a user's contacts in the address book, data management (e.g. publishing information and managing changes in information), synchronizing contact data between a device and network, interaction with legacy systems, sharing, and searching contact information, among other functionality. The above list is not meant to be exhaustive and other functionality for a converged address book would be apparent to those skilled in the art having regard to the present disclosure.

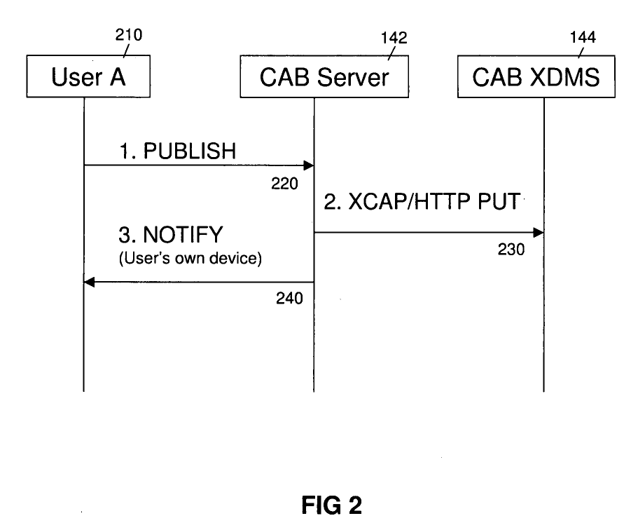

Reference is now made to FIG. 2. FIG. 2 illustrates a data flow diagram for the case where a first user wishes to publish information his/her own data to the CAB.

As seen in FIG. 2, a “User A” 210 communicates with CAB server 142 which communicates with CAB XDMS 144. User A 210 is a combination of CAB user agent 126 and CAB client 122 from FIG. 1.

A first message 220 is sent from user A to CAB server 142. In this case, first message 220 is a publish request in which the CAB user requests to publish his/her contact information to CAB server 142 with possible authorization rules/policies. In a further embodiment, message 220 merely includes an update rather then new contact information. The interface used to publish the data to the CAB Server is OMA DS in one embodiment.

Message 230 is from CAB server 142 to CAB XDMS 144 in which CAB server 142 receives a request and stores the published contact information in CAB XDMS 144. The protocol used in one embodiment is the XML Configuration Access Protocol (XCAP), for example with an HTTP PUT operation. XCAP is defined in IETF RFC 4825, the contents of which are incorporated herein by reference. For those skilled in the art, it will be apparent that the User A 210 can also publish data directly to the CAB XDMS using XCAP i.e. without going through the CAB Server via OMA DS.

In the case that User A 210 is operating with multiple devices, message 240 may be sent from CAB server 142 to the other devices operated by User A 210. The notification is done via the DS notification framework in one embodiment. This is important when the CAB user has multiple devices registered with the CAB service to synchronize with. In the case where the data is directly published to CAB XDMS, the notification mechanism provided by OMA XDM may be utilized.

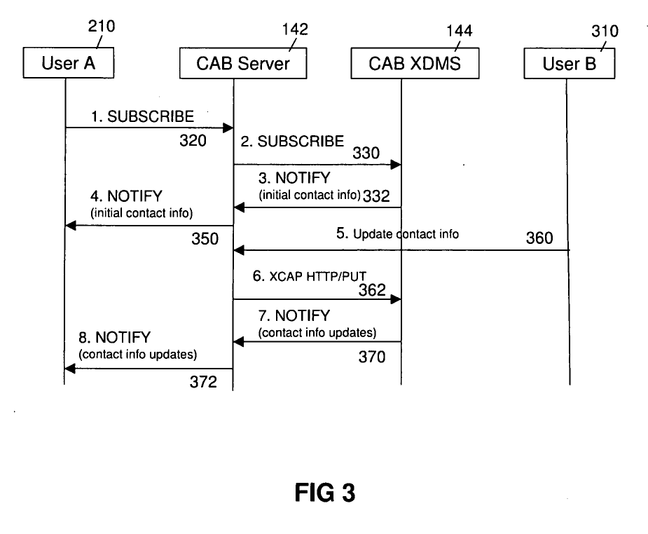

Reference is now made to FIG. 3. FIG. 3 shows a flow diagram for a contact subscribe/notify data flow.

In particular, User A 210 communicates with CAB server 142, which communicates with CAB XDMS 144. Further, a User B 310 communicates with CAB server 142.

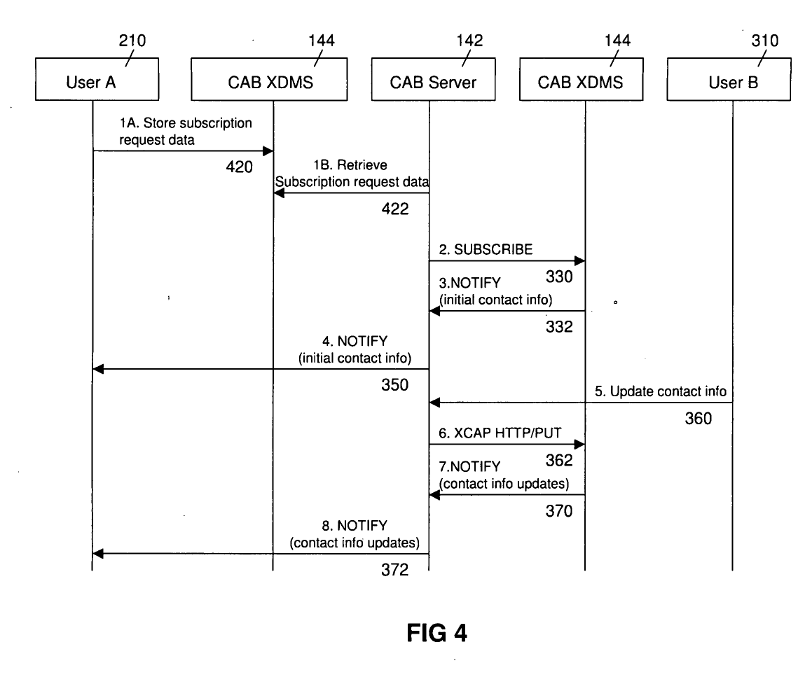

Contact subscribe/notify is a two fold operation wherein a registered CAB user first subscribes to the CAB server 142 for personal contact information of another CAB user including automatic updates. The user may also request the personal contact information from the CAB server 142. For those skilled in the art, it will be apparent that one possible way to do perform a contact subscribe/notify is for a CAB Client 122 (which is a part of User A 210) to send the request to the CAB Server 142 via the CAB XDMS 144, as shown by interface 155. This is typically the case where the CAB server 142 is configured to directly retrieve (with a pull operation) or to be notified (with a prior subscription to the request data updates) of the request data stored by the CAB Client by the CAB XDMS 144. This alternate mechanism using a proxy model is illustrated with regard to FIG. 4 below. In response, the CAB server sends a notification with the contact information or updates corresponding to the subscription.

FIG. 3 illustrates the case where User A 210 is interested in subscribing to contact information for User B 310. In this regard, User A 210 sends message 320 which comprises a request to subscribe to the CAB server 142 for personal contact information of User B 310.

In response CAB server 142 sends message 330 to CAB XDMS 144 after processing the subscription information. The processing in this case is handled using the subscription manager within the CAB server 142. Message 330 ensures that the subscription information is stored in CAB XDMS 144.

CAB XDMS 144 sends a notification message 332 which provides the current contact information for User B 310. This, in turn, is forwarded from CAB server 142 to User A 210 as message 350. The notification to the CAB User A may be done using the notification framework provided by the DS as a result of the subscription manager within the CAB server 142 updating the address book of CAB User A in the network.

User B 310 at a future date updates his/her contact information, for example by publishing such information, as shown by message 360. Message 360 is sent to CAB server 142, which in turns sends message 362 to CAB XDMS 144 providing an XCAP HTTP/PUT in order to store the updated contact information in CAB XDMS 144.

CAB XDMS 144 reviews who is interested in the contact information of User B 310 and discovers that User A 210 has subscribed (and is therefore interested in) to the contact information of User B 310. CAB XDMS 144 therefore sends a notification message 370 to CAB server 142, which in turn forwards the message to User A 210 as notification message 372.

In alternative embodiments, notification messages 370 and 372 could be delayed until synchronization to avoid a user constantly being interrupted by update messages. Alternatively, notification messages 370 and 372 could be throttled based on a throttle or local policy established by CAB Server 142 and/or User A 210.

Reference is now made to FIG. 4. FIG. 4 illustrates the alternative interface between User A 210 and CAB server 142 in which a proxy is utilized. As will be appreciated by those skilled in the art, any proxy may be used. The example of FIG. 4 utilizes the CAB XDMS 144 as a proxy.

In particular, User A 210 sends a message 420 to CAB XDMS 144 in which subscription request data is stored at the CAB XDMS 144.

Subsequently, CAB server 142 retrieves the subscription request, as shown by arrow 422.

The remainder of the messaging is identical to that described above with regard to FIG. 3. In particular, the CAB server 142 sends a subscribe message 330 to CAB XDMS 144 and a notification 332 is provided back to CAB server 142 providing initial contact information. CAB server 142 then provides notification 350 to User A 210 providing the initial contact information.

User B 310 updates his or her contact information at CAB server 142, shown by message 360. CAB server 142 in response forwards the information to CAB XDMS 144, as shown by message 362. This may be done through an XCAP HTTP/PUT message.

In response to the update, CAB XDMS 144 provides a notification 370 with the information updates to CAB server 142. CAB server 142 in turn provides a notification 372 to User A 210 providing the contact information update User B 310.

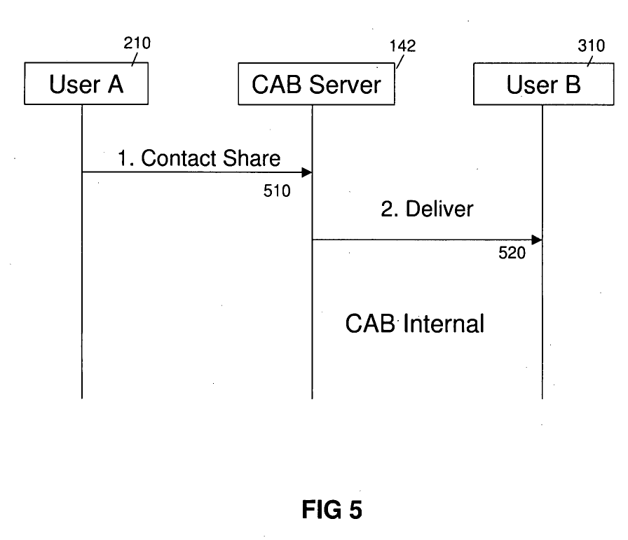

Reference is now made to FIG. 5. FIG. 5 illustrates a flow diagram for a contact share data flow. In particular, contact share is an operation where a registered CAB user shares contact information from his/her address book contact entry or his/her personal contact card with another CAB user. The information being shared from his/her address book can be that of another CAB user or could be a third party non-CAB user.

Contact share is a CAB internal operation. In other words, the information shared is always between authorized CAB users.

Referring to FIG. 5, a User A 210 wishes to share information with a User B 310 both User A 210 and User B 310 are CAB entities. Communication occurs through CAB server 142.

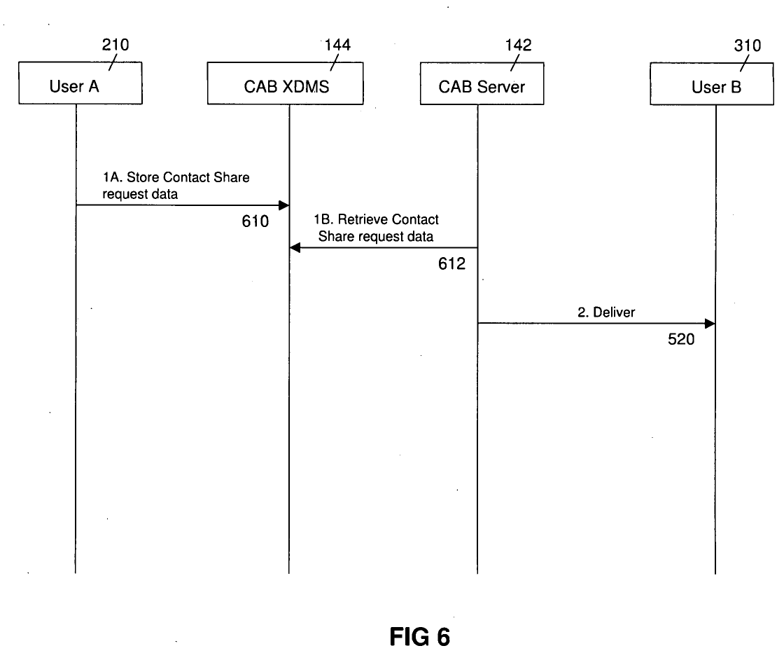

A message 510 is sent from User A 210 to CAB server 142 indicating that User A 210 is requesting CAB server 142 to send the contact entity corresponding to one of his/her contacts from his/her address book to CAB User B 310. For those skilled in art, it will apparent that one possible method to send the contact share request to the CAB Server 142 may be done by a proxy model, for example via the XDMS 144, as shown by interface 155. This is typically the case where the CAB server 142 is configured to directly retrieve (with a pull operation) or to be notified (with a prior subscription to the request data updates) of the request data stored by the CAB Client by the CAB XDMS 144, as shown by interface 155. This alternative interface using a proxy model is shown below with regard to FIG. 6.

CAB sever 142, in response to message 510 and based on suitable policy/authorization, sends message 520 in which the contact information is delivered on behalf of User A to User B. In one embodiment, the intrinsic functional entity within the CAB server 142 responsible for this function may be the ‘contact share’ function. Further, delivery to the User B 310 could be done via 3^{rd} party service server such as a ‘sharing’ service’ in an alternative embodiment.

The method used to transport message 520 could be any delivery method, and includes, but is not limited to, email, SMS, MMS, SOAP or a specific notification message (such as SIP notify) in the CAB architecture.

Reference is now made to FIG. 6. In FIG. 6 a proxy model is used and CAB XDMS 144 is shown as an exemplary proxy.

User A 210 sends a message 610 to CAB XDMS 144 in which contact share request data is provided for storage at CAB XDMS 144.

Subsequently, CAB server 142 retrieves the contact share request data from CAB XDMS 144, as shown by message 612.

Subsequently, CAB server 144 delivers the contact share request data to User B 310, as shown by delivery message 520. Delivery message 520 is identical to the same delivery message from FIG. 5.

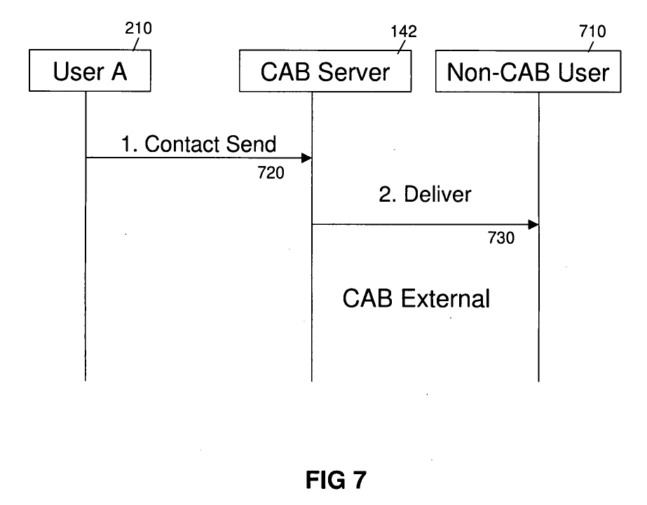

Reference is now made to FIG. 7. FIG. 7 illustrates a data flow for a contact send operation. Contact send is an operation wherein a registered CAB user shares contact information from his/her address book contact entry or his/her personal contact card with a non-CAB user. The information being shared from his/her address book could be that of another CAB user or a third party non-CAB user. Further, delivery to the User B 310 could be done via 3^{rd} party service server such as a ‘sharing’ service’ in an alternative embodiment.

The contact send operation is CAB external. In other words, the information being shared is between a CAB and a non-CAB user.

Referring to FIG. 7, a User A 210 communicates with a non-user CAB 710 utilizing CAB server 142.

User A 210 sends message 720 to CAB server 142. Message 720 is a request to CAB server 142 to send the contact entry of one of the contacts from the address book of User A 210 to non-CAB user 710. For those skilled in art, it will be apparent that one possible method to send the contact share request to the CAB Server 142 may be done by a proxy model, for example via the XDMS 144, as shown by interface 155. This is typically the case where the CAB server 142 is configured to directly retrieve (with a pull operation) or to be notified (with a prior subscription to the request data updates) of the request data stored by the CAB Client by the CAB XDMS 144, as shown by interface 155.

In response to receiving message 720, and based on suitable policy/authorization, CAB server 142 sends message 730 to non-CAB user 710. Message 730 consists of contact information on behalf of User A 210. The intrinsic functional entity within the CAB server responsible for this function may be the ‘contact share’ function.

The method used to transport message 730 may be email, SMS, MMS among others.

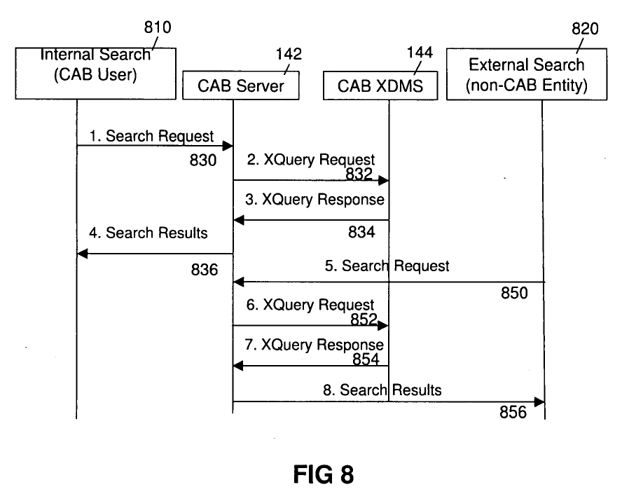

Reference is now made to FIG. 8. FIG. 8 is a data flow diagram showing a contact search operation. Contact search is an operation wherein an entity can search a CAB repository for information based on a selected criteria. The entity may be a CAB user or other external function.

As an example, a CAB user could search the CAB system to provide all names that match the first name “Bill” or have an email address part of a domain “example.com”. A further example could request a match based on a particular location. Other examples would be apparent to those skilled in the art having regard to the present disclosure.

Referring to FIG. 8, the data flow diagram shows searches initiated by both an internal user 810 and an external user 820.

For a search initiated by an internal user 810, message 830 is sent from internal user 810 to CAB server 142. Message 830 is a search request in which the internal user 810 requests CAB server 142 to search the CAB repository for information based on particular search criteria. For those skilled in art, it will be apparent that one possible method to send the contact search request to the CAB Server 142 may be done by a proxy model, for example via the search proxy in the XDMS 144. This is typically the case where the CAB server 142 is configured to directly retrieve (with a pull operation) or to be notified (with a prior subscription to the request data updates) of the request data stored by the CAB Client by the CAB XDMS 144, as shown by interface 155.

In response to receiving to message 830, and based on suitable policy/authorization, CAB server 142 sends message 832 to CAB XDMS 144. Message 832 is a query based on the search criteria and in one embodiment is an XQuery operation or request to initiate a particular XQuery search query expression and/or search function.

CAB XDMS 144 performs the operation or search query/function and returns a response 834 to CAB server 142. Response 834 contains the search results. For those skilled in the art, it will be apparent that the result may be formatted or composed as specified by the XQuery operation or search query/function itself.

CAB server 142 then returns the search results in message 836 to internal user 810. The search results may be aggregated and composed prior to sending the results back to the user. In the case where search function is configured via the search proxy in the XDMS, the search request is made directly to the CAB XDMS 144 without CAB server 142 intervention, and the results are directly send back to the user from the search proxy.

As will be appreciated by those skilled in the art, the results returned in message 836 could be predicated by permissions, policy and authorizations for internal user 810, as well as information within CAB XDMS 144. For example, if a user is searching for all addresses of users named “Bill”, in one embodiment “Bill Smith” may specify his information to be private. In this case, “Bill Smith” may set the information visibility or policy to be private and therefore preclude his name from being returned with the search results of message 836.

In another embodiment, privacy may be determined based on classes of users. Thus, “Bill Smith” may indicate that his information is not to be shared with the general public, but could be provided to his individuals at his work domain (i.e. all users with the domain name of ‘example.com’ in their public identity).

Other examples of privacy and authorization would be evident to those skilled in the art.

Referring again to FIG. 8. A non-CAB entity (external user or service) 820 could also request a search. In this case, a search request 850 is sent from a non-CAB entity 820 to the CAB server 142. Assuming the non-CAB entity 820 had the correct authorization and privileges, CAB server 142 could then send message 852 to CAB XDMS 144. Message 852 is a query operation and could be an XQuery operation in one embodiment. Alternatively, message 852 may refer to a particular XQuery search query expression and/or search function.

CAB XDMS 144 executes or performs the operation or search query/function and sends message 854 in response. The search results may be aggregated and composed prior to sending the results back in message 854.

CAB server 142 then sends the search results in message 856 to external user 820.

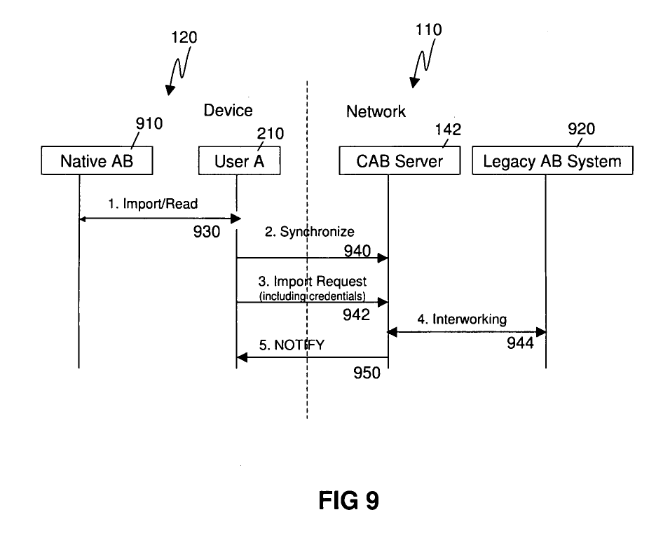

Reference is now made to FIG. 9. FIG. 9 is a data flow diagram showing interaction with legacy or non-CAB address book systems. As will be appreciated, interaction with legacy address books and systems is important for the adoption of a converged address book, particularly from a backwards compatibility standpoint. The legacy address book can be either on a device or on a network. FIG. 9 illustrates interaction with both legacy address books and systems.

FIG. 9 illustrates both network side 110 functionality and device side 120 functionality. On device side 120 a native address book 910 communicates with User A 210. As will be appreciated, native address book 910 could be equivalent to legacy address book 128 from FIG. 1.

User A 210 imports the Native address book 910 through message 930 as a result of import request. Message 930 is an import of a user's personal contact information and address book information to the converged address book of User A 210 through an interface provided by the native address book agent.

User A 210 then synchronizing CAB server 142 as shown with message 940. The information from native address book 910 is synchronized or uploaded to the network-based repository through the CAB server 142.

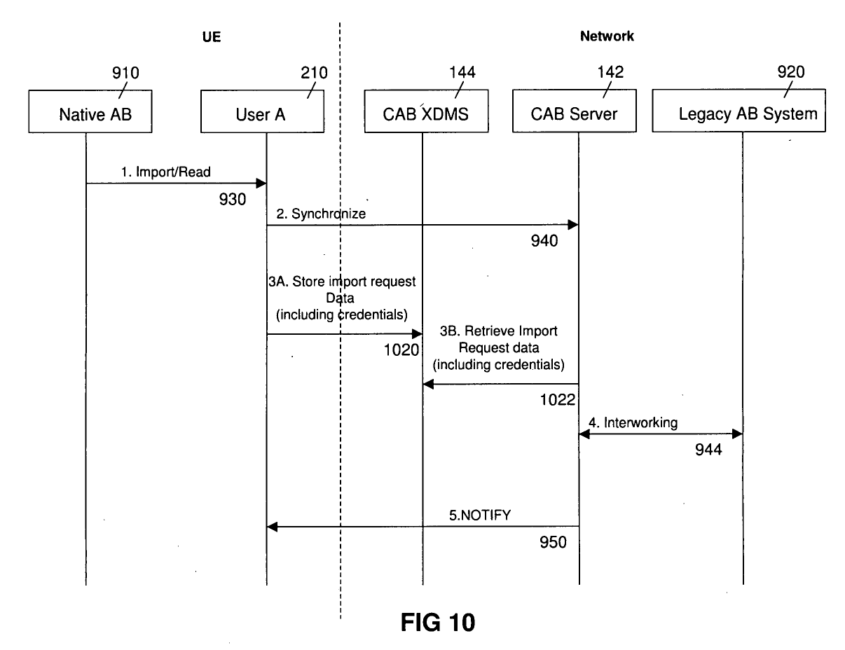

In another embodiment a request message 942 could be sent from User A 210 to CAB server 142. Message 942 allows User A 210 to request CAB server 142 to import address book information from legacy network-based address book systems by providing credentials to access the legacy address book system 920. For those skilled in art, it will be apparent that one possible method to perform an import of network-based legacy systems is for a CAB Client 122 (which is part of User A 210) to send the import request to the CAB Server 142 through a proxy model, for example via the XDMS 144. This is typically the case where the CAB server 142 is configured to directly retrieve (with a pull operation) or to be notified (with a prior subscription to the request data updates) of the request data stored by the CAB Client by the CAB XDMS 144, as shown by interface 155. This alternative interface utilizing the proxy model is shown below in FIG. 10.

In response to message 942, CAB server 142 connects to legacy address book system 920 as shown by arrow 944 and retrieves the address book data from the legacy address book system. In one embodiment, the intrinsic function of interworking with the legacy address book system may be handled through an ‘interworking’ function within the CAB server 142.

In message 950 CAB server 142 notifies User A 210 that the data has been imported from the legacy address book system 940. The notification may be done using OMA DS notification message as result of the interworking function storing the imported data in the network-based address book e.g. CAB XDMS 144.

Reference is now made to FIG. 10. FIG. 10 shows the interworking between a CAB system and a legacy address book system utilizing a CAB XDMS as a proxy.

In particular, a native address book 910 on a device communicates with User A 210 and User A 210 is allowed to import or read data from native address book 910, as shown by the import/read message 930.

User A 210 further synchronizes with CAB server 142, as shown by synchronization message 940.

Utilizing CAB XDMS 144 as a proxy, User A 210 sends a storage request 1020 to CAB XDMS 144. Storage request 1020 stores the request data to import address book information from a legacy network-based address book system by providing credentials to access the legacy address book system 920.

CAB server 142 then retrieves the import request data and credentials, as shown by message 1022.

Subsequently, CAB server 1022 provides interworking with legacy address book system 920 as shown by arrow 944 and CAB server 142 may also provide a notification 950 to User A 210 in a similar manner to that described with regard to FIG. 9 above.

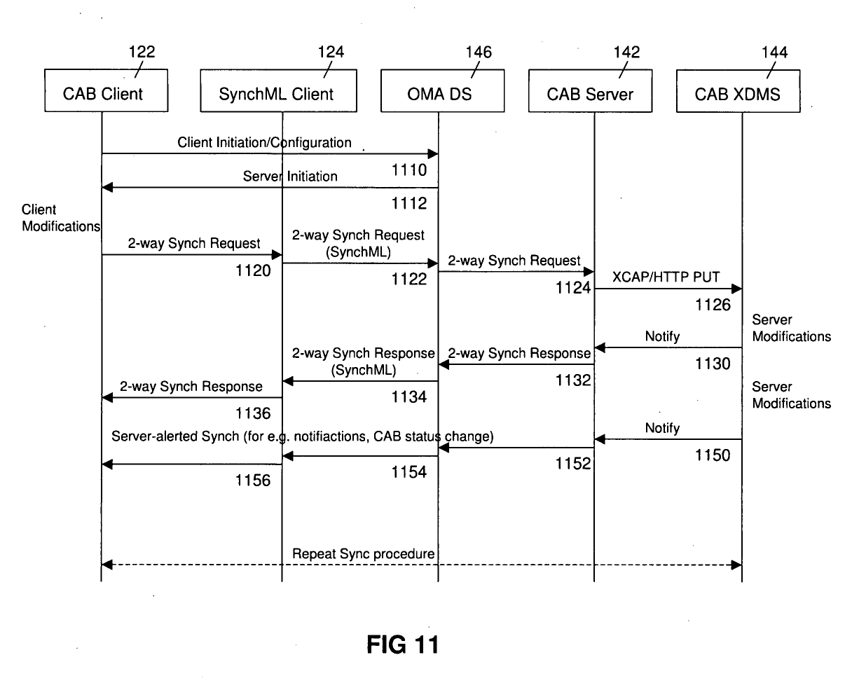

Reference is now made to FIG. 11. FIG. 11 shows a flow diagram illustrating device and CAB data synchronization. This operation involves synchronization of CAB-related data between the network and one or more CAB devices for a given CAB user. Examples of CAB-related data include personal contact card address book information, CAB User preferences, and CAB User policies, among others. Examples of CAB devices include wireless devices, personal computers, laptops, among others. Data synchronization facilitates the correspondence and backup of CAB data between the device and network.

Referring to FIG. 11. A CAB client 122 communicates with OMA DS enabler 146 and sends a message 1110. Message 1110 is an initialization request to the OMA DS enabler through the SyncML client 124 with configuration information. In response OMA DS enabler 146 sends a server initiation message 1112 back to CAB client 122. Message 1112 is an initialization package with configuration information.

At a later date, assuming that there are data modifications at the client and also at the server database, CAB client 122 makes a 2-way request 1120 to SynchML client 124.

In response to receiving message 1120 SyncML client 124 forwards a two-way synch request message 1122 to OMA DS enabler 146. The OMA DS enabler 146, upon receiving message 1122, processes it and forwards it to CAB server 142 to store the information. This is performed with message 1124. Further CAB server 142 forwards the information to CAB XDMS 144 as message 1126.

In response to the 2-way synchronization request server modifications are applied and propagated back from CAB XDMS 144 to CAB client 122. This is done via notify message 1130 (assuming a prior subscription to changes in CAB XDMS is in place) being sent from CAB XDMS 144 to CAB server 142. CAB server 142 then provides a 2-way synch response message 1132 to OMA DS enabler 146.

OMA DS enabler 146 returns the changes back to the SyncML client 124 in message 1134. In one embodiment the format of the message is SyncML format.

Subsequently, the SyncML client 124 notifies CAB client 122 of the changes in message 1136 to allow the CAB client to reconcile the data.

For those skilled in the art, OMA DS enabler is only a logical function and may be implemented together with the CAB Server as a single logical or physical entity, in which case the additional message steps between the OMA DS and CAB Server may not be necessary.

In a further embodiment, assuming that changes occur at the CAB XDMS 144 as a result of valid contact subscriptions, contact share, import of data from non-CAB or legacy systems, CAB status changes, among others, the CAB XDMS 144 notifies the CAB server 142 using message 1150. The CAB server 142, through the OMA DS enabler 146 can initiate a server-alerted synch back to CAB client 122 requesting the CAB client 122 to start a specific type of synchronization with CAB server 142.This is done through messages 1152, 1154 and 1156 as seen in FIG. 8. Based on the server alerted synchronization request notification from CAB server 142 to CAB client 122 the messages from 1120 to 1136 may be repeated. The server may also request other types of synchronization requests such as slow synchronization, one-way synchronization, among others.

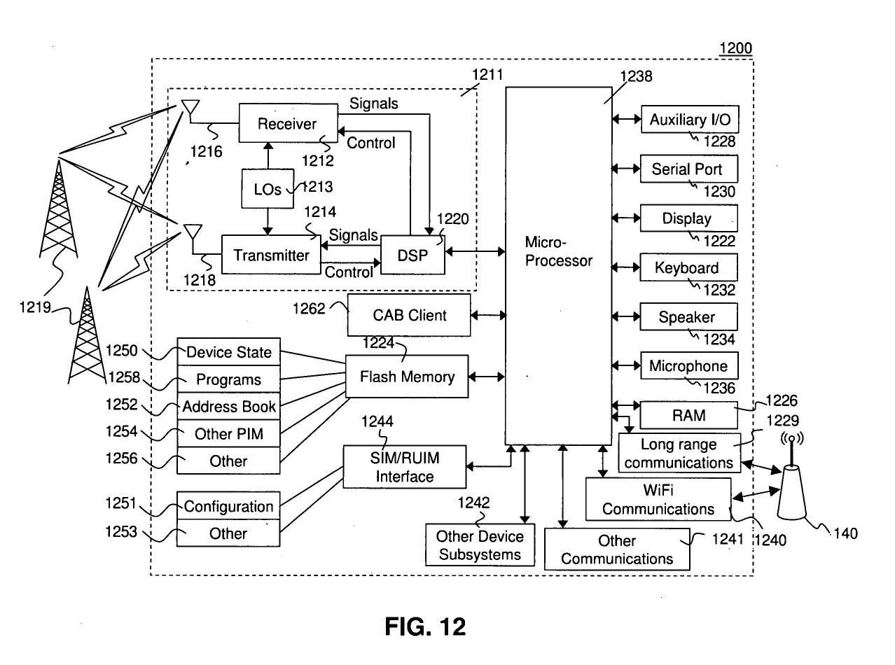

As will be appreciated, the above can be implemented on any mobile device. One exemplary mobile device is described below with reference to FIG. 12. This is not meant to be limiting, but is provided for illustrative purposes.

FIG. 12 is a block diagram illustrating a mobile device apt to be used with preferred embodiments of the apparatus and method of the present application. Mobile device 1200 is preferably a two-way wireless communication device having at least voice communication capabilities. Depending on the exact functionality provided, the wireless device may be referred to as a data messaging device, a two-way pager, a wireless e-mail device, a cellular telephone with data messaging capabilities, a wireless Internet appliance, or a data communication device, as examples.

Where mobile device 1200 is enabled for two-way communication, it will incorporate a communication subsystem 1211, including both a receiver 1212 and a transmitter 1214, as well as associated components such as one or more, preferably embedded or internal, antenna elements 1216 and 1218, local oscillators (LOs) 1213, and a processing module such as a digital signal processor (DSP) 1220. As will be apparent to those skilled in the field of communications, the particular design of the communication subsystem 1211 will be dependent upon the communication network in which the device is intended to operate.

Network access requirements will also vary depending upon the type of network 1219. In some CDMA/UMTS networks network access is associated with a subscriber or user of mobile device 1200. A mobile device may require a removable user identity module (RUIM) or a subscriber identity module (SIM) card in order to operate on a network. The SIM/RUIM interface 1244 is normally similar to a card-slot into which a SIM/RUIM card can be inserted and ejected like a diskette or PCMCIA card. The SIM/RUIM card can have approximately 64K of memory and hold many key configuration 1251, and other information 1253 such as identification, and subscriber related information.

When required network registration or activation procedures have been completed, mobile device 1200 may send and receive communication signals over the network 1219. As illustrated in FIG. 12, network 1219 can consist of multiple base stations communicating with the mobile device.

Signals received by antenna 1216 through communication network 1219 are input to receiver 1212, which may perform such common receiver functions as signal amplification, frequency down conversion, filtering, channel selection and the like, and in the example system shown in FIG. 12 analog to digital (A/D) conversion. A/D conversion of a received signal allows more complex communication functions such as demodulation and decoding to be performed in the DSP 1220. In a similar manner, signals to be transmitted are processed, including modulation and encoding for example, by DSP 1220 and input to transmitter 1214 for digital to analog conversion, frequency up conversion, filtering, amplification and transmission over the communication network 1219 via antenna 1218. DSP 1220 not only processes communication signals, but also provides for receiver and transmitter control. For example, the gains applied to communication signals in receiver 1212 and transmitter 1214 may be adaptively controlled through automatic gain control algorithms implemented in DSP 1220.

Mobile device 1200 preferably includes a microprocessor 1238 which controls the overall operation of the device. Communication functions, including at least data and voice communications, are performed through communication subsystem 1211. Microprocessor 1238 also interacts with further device subsystems such as the display 1222, flash memory 1224, random access memory (RAM) 1226, auxiliary input/output (I/O) subsystems 1228, serial port 1230, one or more keyboards or keypads 1232, speaker 1234, microphone 1236, other communication subsystem 1240 such as a short-range communications subsystem, a long range communication subsystem 1229 such as, but not limited to a WiMAX system, and any other device subsystems generally designated as 1242. Serial port 1230 could include a USB port or other port known to those in the art.

Some of the subsystems shown in FIG. 12 perform communication-related functions, whereas other subsystems may provide “resident” or on-device functions. Notably, some subsystems, such as keyboard 1232 and display 1222, for example, may be used for both communication-related functions, such as entering a text message for transmission over a communication network, and device-resident functions such as a calculator or task list.

Operating system software used by the microprocessor 1238 is preferably stored in a persistent store such as flash memory 1224, which may instead be a read-only memory (ROM) or similar storage element (not shown). Those skilled in the art will appreciate that the operating system, specific device applications, or parts thereof, may be temporarily loaded into a volatile memory such as RAM 1226. Received communication signals may also be stored in RAM 1226.

As shown, flash memory 1224 can be segregated into different areas for both computer programs 1258 and program data storage 1250, 1252, 1254 and 1256. These different storage types indicate that each program can allocate a portion of flash memory 1224 for their own data storage requirements. Microprocessor 1238, in addition to its operating system functions, preferably enables execution of software applications on the mobile device. A predetermined set of applications that control basic operations, including at least data and voice communication applications for example, will normally be installed on mobile device 1200 during manufacturing. Other applications could be installed subsequently or dynamically.

A preferred software application may be a personal information manager (PIM) application having the ability to organize and manage data items relating to the user of the mobile device such as, but not limited to, e-mail, calendar events, voice mails, appointments, and task items. Naturally, one or more memory stores would be available on the mobile device to facilitate storage of PIM data items. Such PIM application would preferably have the ability to send and receive data items, via the wireless network 1219. In a preferred embodiment, the PIM data items are seamlessly integrated, synchronized and updated, via the wireless network 1219, with the mobile device user's corresponding data items stored or associated with a host computer system. Further applications may also be loaded onto the mobile device 1200 through the network 1219, an auxiliary I/O subsystem 1228, serial port 1230, short-range communications subsystem 1240, long range communications subsystem 1229, or any other suitable subsystem 1242, and installed by a user in the RAM 1226 or preferably a non-volatile store (not shown) for execution by the microprocessor 1238. Such flexibility in application installation increases the functionality of the device and may provide enhanced on-device functions, communication-related functions, or both. For example, secure communication applications may enable electronic commerce functions and other such financial transactions to be performed using the mobile device 1200.

In a data communication mode, a received signal such as a text message or web page download will be processed by the communication subsystem 1211 and input to the microprocessor 1238, which preferably further processes the received signal for element attributes for output to the display 1222, or alternatively to an auxiliary I/O device 1228.

A user of mobile device 1200 may also compose data items such as email messages for example, using the keyboard 1232, which is preferably a complete alphanumeric keyboard or telephone-type keypad, in conjunction with the display 1222 and possibly an auxiliary I/O device 1228. Such composed items may then be transmitted over a communication network through the communication subsystem 1211.

For voice communications, overall operation of mobile device 1200 is similar, except that received signals would preferably be output to a speaker 1234 and signals for transmission would be generated by a microphone 1236. Alternative voice or audio I/O subsystems, such as a voice message recording subsystem, may also be implemented on mobile device 1200. Although voice or audio signal output is preferably accomplished primarily through the speaker 1234, display 1222 may also be used to provide an indication of the identity of a calling party, the duration of a voice call, or other voice call related information for example.

Serial port 1230 in FIG. 12 would normally be implemented in a personal digital assistant (PDA)-type mobile device for which synchronization with a user's desktop computer (not shown) may be desirable, but is an optional device component. Such a port 1230 would enable a user to set preferences through an external device or software application and would extend the capabilities of mobile device 1200 by providing for information or software downloads to mobile device 1200 other than through a wireless communication network. The alternate download path may for example be used to load an encryption key onto the device through a direct and thus reliable and trusted connection to thereby enable secure device communication. As will be appreciated by those skilled in the art, serial port 1230 can further be used to connect the mobile device to a computer to act as a modem.

WiFi Communications Subsystem 1240 is used for WiFi Communications and can communication with access point 140. Long range communications subsystem 1229 is used for wireless of data transmission of data and, when a WiMAX system, can communicate with WiMax base station such as access point 140.

Other communications subsystems 1241, such as a short-range communications subsystem, is a further component which may provide for communication between mobile device 1200 and different systems or devices, which need not necessarily be similar devices. For example, the subsystem 1241 may include an infrared device and associated circuits and components or a Bluetooth™ communication module to provide for communication with similarly enabled systems and devices.

CAB Client 1262 could interact with processor 1238. Further, the SynchML Client could exist with the programs 1258 on device 1200.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A converged address book client on a device configured to manage contact information through a converged address book system, the converged address book client comprising:
an interface for interacting with a converged address book server; and
a synchronization interface configured to communicate with a synchronization module for interacting with a data synchronization enabler for synchronization between the converged address book client and converged address book server;
wherein the interface allows the converged address book client to manage contact information by making requests to and receiving responses from the converged address book server.

2. The converged address book client of claim 1, wherein the interface between the converged address book client and converged address book server is a direct interface.

3. The converged address book client of claim 2, wherein the interface is implemented using one of a hypertext transfer protocol or session initiation protocol.

4. The converged address book client of claim 2, wherein the interface carries one or more requests selected from the group consisting of: a publish request; a subscription request; a share request; a search request, an authentication request; an import request; and a user preferences request.

5. The converged address book client of claim 1, wherein the interface between the converged address book client and converged address book server is an indirect interface.

6. The converged address book client of claim 5, wherein the indirect interface utilizes a converged address book extensible markup language document management server as a proxy.

7. The converged address book client of claim 1, further configured to utilize an interface to interact with a legacy address book on the device.

8. The converged address book client of claim 1, further comprising a converged address book user agent configured to provide a user interface for a converged address book application.

9. The converged address book client of claim 1, further configured to receive notifications from a converged address book server.

10. A converged address book server within a converged address book system, the converged address book server comprising:
an interface for interacting with a converged address book client;
a data synchronization manager configured to synchronize information between at least one converged address book user device and the converged address book server;
a data synchronization interface, said data synchronization interface configured to communicate between the data synchronization manager and a data synchronization enabler for synchronizing data with the converged address book client;
a subscription manager configured to manage converged address book subscription and authorization information;
a document management interface for communicating with a converged address book extensible markup language document management system; and
an extensible markup language document management client configured to access and manipulate converged address book data stored in the extensible markup language document management system.

11. The converged address book server of claim 10, further comprising a contact share unit configured to manage messaging actions between a converged address book system user and a non-converged address book system user.

12. The converged address book server of claim 10, further configured to provide notifications to a converged address book client.

13. The converged address book server of claim 10, wherein the interface carries one or more requests selected from the group consisting of: a publish request; a subscription request; a share request; a search request, an authentication request; an import request; and a user preferences request.

14. The converged address book server of claim 10, wherein the interface is a direct interface between the converged address book server and the converged address book client.

15. The converged address book server of claim 10, wherein the interface is an indirect interface between the converged address book server and the converged address book client.

16. The converged address book server of claim 15, wherein the indirect interface utilizes a converged address book extensible markup language document management server as a proxy.

17. The converged address book server of claim 10, further comprising a server interface for communications with remote converged address book servers, said server interface permitting interworking with remote converged address book servers.

18. The converged address book server of claim 10, further comprising an interworking module for interworking between said converged address book server and legacy network based address book systems using a legacy interface.

19. The converged address book server of claim 10, further comprising a service aggregator interface for communication with a service aggregator, said communication allowing interworking with external enablers.

20. A network repository for use in a converged address book system comprising:
memory for storing converged address book system related information;
an interface allowing access to the converged address book system related information by a converged address book client or converged address book server,
wherein said network repository further specifies data semantics associated with said converged address book system related information.

21. The network repository of claim 20 wherein the network repository is a converged address book extensible markup language document management server.

22. The network repository of claim 20, wherein the converged address book related information comprises at least one of an address book, a personal contact card, user preferences and user policies.

23. The network repository of claim 20, wherein the interface provides for the network repository to act as an intermediary between the converged address book client and converged address book server.

24. The network repository of claim 20, further comprising a processor configured to apply transforms to assist in creation of contact views based on authorizations.

25. The network repository of claim 24, wherein said authorizations relate to subscription authorizations.
